(19) United States
(12) Patent Application Publication
(10) Pub. No.: US 2009/0190441 A1
(43) Pub. Date: Jul. 30, 2009

(54) AUTONOMOUS ULTRASONIC INDOOR TRACKING SYSTEM

(75) Inventors: Junhui ZHAO, Beijing (CN); Yongcai Wang, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 12/361,246

(22) Filed: Jan. 28, 2009

(30) Foreign Application Priority Data
Jan. 29, 2008 (CN) 200810006317.0

(51) Int. Cl. G01S 3/80

(52) U.S. Cl. 367/128

(57) ABSTRACT

The present invention provides a Positioning on One Device (POD) for locating and tracking objects and an autonomous ultrasound indoor track system (AUITS) and method for locating objects by using the POD. The AUITS can comprise: a tag device installed on a mobile object, which includes radio frequency (RF) and ultrasound transmitters for transmitting RF and ultrasound signals; and a POD for receiving the RF and ultrasound signals transmitted from the tag device to locate the mobile object. The POD can comprise: a plurality of leaf modules, each of the leaf modules including a positioning signal receiver for receiving the positioning signals (e.g. ultrasound signal) transmitted from the tag device, wherein there is a known structural topology relationship between the plurality of leaf modules. Then, the positioning signal detection times from respective positioning signal receivers and the structural topology relationship of the POD can be used for calculation of the position of the object. Compared with the prior arts, the POD and the AUITS system of the present invention presents several advantages, such as high accuracy, easy deployment, calibration free, low cost, in-device coordination, and flexibility.

### FIELD OF THE INVENTION

This invention relates to Indoor Location System (ILS) and position sensing, and more particularly, to provide an ultrasound based positioning device, an autonomous ultrasound positioning system and method using the positioning device for locating and tracking mobile objects.

### BACKGROUND

In pervasive computing environments, Indoor Location System (ILS) is required to supply positioning services to enhance existing applications as well as enable new ones. Currently, there is an increasing market need for highly accurate tracking of people and assets in real time, in many different application areas including healthcare, security, coalmine, subway, smart building, restaurant etc. Some potential application scenarios are listed as following.

In office environment, employees are required to access confidential information database in certain secure area. Out of such area, any access will be prohibited. For instance, members of different groups can access their group-dependent information database at their working zone, and some secure computers can be used only when they are located at a certain area. These above policies can be enforced by using Location-based service (LBS) than by any other existing mechanisms. Also, LBS is extremely useful in an office environment where people do not have permanent desks, but just take any available space because ILS can provide the ability to display an interactive real time map, which shows who is in the office and where they are located.

In addition, in hospital, the patients, staff and asset can be tracked in real time by using ILS, so that record keeping and workflow can be significant simplified. For example, when a doctor walks up to a patient, the relevant records just pop up on his tablet PC automatically, and a form is filled out with the current data and time so the doctor just has to record any additional details of this interaction.

LBS can bring users a new Human-Machine Interaction experience in daily working life. When the user is in front of a computer, it knows who the user is and automatically displays his\her desktop on the screen. Imagine that the user is viewing a favorite video clip. Computer can pause such a video intelligently if he/she suddenly goes away for anything else. The computer will not continue to play the video file until user comes back. Other examples here are, if a phone call comes in for the user, it can automatically be routed to the phone nearest to him/her.

Furthermore, training exercises for military personnel, firemen, athletes and others can be significantly enhanced by using ILS.

Basically, ILS is a technology with broad applicability in many application areas and industries. The application scenarios described above are just some small samples of the possibilities.

As described above, since there is an increasing market need for accurately tracking people and asset in real time, many positioning systems have been developed to provide location based services. However, these systems are unsatisfying to users and currently, most of them are staying in the laboratory or university. The main reason of user resistance is the considerable installation and calibration effort, which is special requirement for a positioning system to be installed and calibrated before its use. In fact, according to the basic triangulation method mostly used in most ILSs, many various sensors have to be manually installed and calibrated. Thus, these above requirements of the existing ILSs result in the following challenges.

(1) High Installation Cost

Current indoor location systems always require users to install many various kinds of sensors as reference points into the room to be covered so that a lot of installation efforts should be needed for users, for example, punching the wall, wire routing, power supplying etc.

(2) Manually Calibration

The actual position of reference points should be firstly calibrated before the positioning system is put into use. Currently, such a calibration process mainly depends on manual effort that is cumbersome and not accurate. On the other hand, the learning based positioning systems basically employ an off-line training phase to achieve a map between signal space and physical space, which also need much manual efforts.

(3) Complex Network Protocols

Many current positioning systems need to maintain complex signaling and network protocol to coordinate the network of sensors for synchronizing and processing data etc. Inaccuracy of coordination caused by environmental disturbances will result in localization inaccuracy.

In general, there are three technologies commonly used for indoor positioning systems—infrared, radio frequency (RF) and ultrasound positioning systems. For example, in U.S. Pat. No. 6,216,087 to R. Want entitled “Infrared Beacon Position System”, a proximity based infrared positioning system “Active badge” (referred to as “Active Badge system” below) is provided, which is build over bidirectional infrared link where one infrared beacon is deployed in each room and the mobile unit is a small, lightweight infrared transceiver that broadcast an unique ID every a fixed interval. Since infrared signals can hardly penetrate walls, ID broadcasts are easily contained within an office, providing highly accurate localization at room granularity.

In P. Bahl. etc. “RADAR: An In-Building RF-based User Location and Tracking System” in Proc. IEEE INFOCOM, 2000, a RF based location system (referred to as “RADAR system” below) based on received signal strength of 802.11 wireless network is presented. The basic RADAR location method is performed in two phases. First, in an off-line phase, the system is calibrated and a model is constructed of received signal strengths at a finite number of locations distributed about the target area. Second, during on-line operation in the target area, mobile units report the signal strengths received from each base station and the system determines the best match between the on-line observations and any point in the on-line model. The location of the best matching point is reported as the location estimate.

The following are examples of ultrasound based indoor positioning systems currently used in the prior art.

For example, in “Bat” system of U.S. Pat. No. 6,493,649 to Jones entitled “Detection system for determining positional and other information about objects”, users wear small badges which emit an ultrasonic pulse when radio-triggered by a central system. The system determines pulse TOA (Time of Arrival) from the badges to dense receiver array installed on the ceiling, and calculates the 3D positions of the badges based on multilateration algorithm.

Another system, “Cricket” location system cited from B. Nissanka, etc. “The Cricket Location-Support System” In Proceedings of the Sixth International Conference on Mobile Computing and Networking, Boston, Mass., USA, August 2000, consists of independent, unconnected beacons distributed throughout a building. The beacons send an RF signal while simultaneously sending an ultrasonic pulse. Small devices called listeners, carried by users, infer their locations using time-of-flight methods.

In addition, “Sonitor” system of Pat. No. WO 03/087871 A1 to S. Holm entitled “A system and method for position determination of objects” provides an ultrasound-only indoor positioning system to achieve room-granularity location accuracy. In the Sonitor system, tag devices transmit 20 kHz to 40 kHz ultrasound signals to receivers located in the listening area. Through frequency modulation, each tag device communicates a unique signal to the receivers, using algorithms to read the signals and then forward their ID to a central server.

Table. 1 shows a detailed comparison between the three signals (infrared, RF and ultrasound) when used for indoor positioning applications. For purposes of convenience, to make the comparison we selected the current representative systems for the three signals respectively, i.e., the “Active Badge” system for Infrared, the “RADAR” system for RF and the “Bat” system for Ultrasound.

TABLE 1
Comparison of Current Positioning Techniques

| | Infrared | | Ultrasound |
|---|---|---|---|
| | (Active Badge) | RF (Radar) | (Bat) |
| Accuracy | Room-granularity | 3~6 m | 3~5 cm |
| Location Strategy | Proximity | RSSI Model | TOA based |
| | | | Triangulation |
| Range | 5 m | 100 m | 10 m |
| Propagation Speed | 3 * 10⁸ m/s | 3 * 10⁸ m/s | 340 m/s |
| Working Frequency | 20 M~45 MHz | 433 M, 915M, | 40 KHz |
| | | 2.4 GHz | |
| Need Explicit | Yes | No | No |
| Action | | | |
| Cost | Low | Expensive | Low |
| Power Consumption | Low | Low | Low |
| Health Effect | Some | Some | No harm if |
| | | | SPL < 110 dB |
| Typical | Ambient Light, | Multi-path, | Environmental |
| Interferences | Reverberation | Perturbation | Noise, |
| | | | Reverberation |

Note:
RSSI denotes Received Signal Strength;
TOA denotes Time of Arrival;
SPL denotes Sound Pressure Level

From this table 1, we can basically conclude that infrared based location systems is rarely used due to low accuracy and vulnerability to natural light; and that RF systems which use signal strength to estimate location can not yield satisfactory results because RF propagation within buildings deviates heavily from empirical mathematical models. Therefore, ultrasound based system is increasingly an attractive form of positioning because it offers a high accuracy and low cost solution. Narrowband ultrasonic transducers are cheap and readily available. Furthermore, expensive, high-precision oscillators are unnecessary because ultrasonic signals travel relatively slowly when compared to other signals such as RF.

However, there are some weaknesses with current ultrasonic positioning systems as following:
1. It is awkward to deploy such a networked system into practical scenario, needing high installation and maintenance costs.
2. The efforts to manually label the actual positions of all ultrasound sensors are cumbersome.
3. A complex singling and network protocol among transmitter, receivers and the base station is needed to synchronize time and communicate data via wireless links. The time jitters introduced by software/hardware and environmental disturbances will cause localization inaccuracy.
4. Since at least three distance samples are needed to estimate the object's position, very dense ultrasound sensors need to be deployed into building so that system cost is high.

Particularly, for the ultrasound positioning systems as described above, there are some weaknesses as following. First, as to the “Bat” system, it needs dense deployment of a network of ultrasound receivers on the ceiling and to localize target with multilateration algorithm that need at least 4 distance samples to estimate the object's position. For the “Cricket” system, besides the general problems, it is a location-support system rather than a location-tracking system, so that the client side needs to have enough computing power to infer their own positions. If a tracking system is expected, objects need to report their positions to a server that may cause more RF channel congestions. Cricket receiver hears only one ultrasound beacon at a time, and may move between chirps from different beacons. As a result, there is no guaranteed simultaneity of distance samples that can lead to incorrect position estimation. For the “Sonitor” system, it is vulnerable to interference due to environmental noise, reverberation and Doppler shift. The system also requires a wideband ultrasound transducer which is much more expensive than a narrowband one, thereby increasing the cost of the positioning system.

### SUMMARY OF THE INVENTION

Based on the above analysis, it is needed to design a positioning device and an ILS, which are highly accurate, easy to deploy, calibration free, low cost and simply coordinated. The present invention provides an Autonomous Ultrasound Indoor Track System (AUITS) for positioning and tracking mobile objects within buildings. The core of the AUITS lies in the idea of Positioning on One Device (POD), which uses ultrasound as positioning medium, and exploits structural topology and in-device coordination to solve the above-mentioned challenges. The POD is a compact device (looks almost like a Frisbee) when it is not being use, which can be easily installed anywhere according to the user's requirement. When being used, the POD can spread several telescopic rods like the skeleton of an umbrella, and at the end of each rod there is an ultrasound receiver. Since the topology of the extended POD is fixed and the coordinates of such receivers can be calculated easily, manual calibration of the ultrasound receivers' coordinates is no longer needed. Besides this, since all of the receivers are on one device, the complex wireless-based signaling and network protocols are no longer needed. When the POD is deployed, a tag device with ultrasound transmitter can be carried by the mobile object to be located, which works in an active transmission mode. In this way the POD and the tag device can form the AUITS system of the present invention.

According to the first aspect of the invention, it is provided a positioning device for locating objects, comprising: a plurality of leaf modules, each of the leaf modules including a positioning signal receiver for receiving positioning signals transmitted from the object, wherein there is a known structural topology relationship between the plurality of leaf modules; and a computing module for computing the position of the object according to positioning signal detection times from respective positioning signal receivers and the structural topology relationship. In some embodiments, the positioning device may also comprise a head module, which comprises a synchronization signal receiver for receiving synchronization signal, and a synchronization unit for performing synchronization with the object.

According to the second aspect of the invention, it is provided a method for locating objects using a positioning device, the positioning device comprises a plurality of leaf modules, each of the leaf modules includes a positioning signal receiver for receiving positioning signals transmitted from the object, wherein there is a known structural topology relationship between the plurality of leaf modules, the method comprising: starting the positioning signal receivers and recording the start time T_{0,i} of the positioning signal receivers, wherein i is an index for the ith positioning signal receiver; receiving the positioning signals from the object by each of the positioning signal receivers and recording its positioning signal detection time Δ_{t,i}*; and calculating the position of the object based on the recorded positioning signal detection times and the structural topology relationship of the positioning device.

According to the third aspect of the invention, it is provided an autonomous ultrasound track system for locating objects, comprising: a tag device installed on a object, which includes a positioning signal transmitter for transmitting positioning signals; and a positioning device for locating the position of the object. The positioning device comprises: a plurality of leaf modules, each of the leaf modules including a positioning signal receiver for receiving the positioning signals transmitted from the object, wherein there is a known structural topology relationship between the plurality of leaf modules; and a position computing module for computing the position of the object according to positioning signal detection times from respective positioning signal receivers of the positioning device and the structural topology relationship.

According to the fourth aspect of the invention, it is provided an ultrasound signature method, comprising: obtaining an ID code specific to an object; encoding the ID code into a sequence of ultrasound pulses to be transmitted; and transmitting the encoded sequence of ultrasound pulses. In one example, a unique ID code is generated at the mobile object and is modulated into a series of ultrasonic pulses by varying the time interval between the pulses. Of course, the present invention should not be limited to only this particular ultrasound signature method. In other examples, other technical means well-known in the art, such as time encoding, amplitude modulation, frequency modulation, phase modulation and the like, can also be used to implement ultrasound signature.

According to the fifth aspect of the invention, it is provided a tag device, comprising: a synchronization signal transmitter for transmitting synchronization signals; and a positioning signal transmitter for transmitting positioning signals, wherein a predetermined period of time is inserted between the transmission of the synchronization signals and the positioning signals.

Compared with the prior arts, the AUITS system of the present invention presents several advantages, such as easy deployment, calibration free, in-device coordination, better accuracy, and flexibility.

The AUITS of the present invention employs an autonomous positioning device, i.e. POD, to process airborne ultrasound signal collection and to make position inferring, instead of networked ultrasound sensors as the prior arts deployed, and thus it is easily to be installed and maintained. In addition, the structural topology of the POD is designed that coordinates (structural topology relationship) of head and leaf modules can be automatically obtained by formulas. Therefore, manual calibration is no longer needed.

In addition, as described above, a collaborative mechanism based on role differentiation strategy is presented in the present invention for the construction of POD. Since head module and leaf modules are on one device, although they are assigned different jobs, they work in perfect coordination to jointly carry out mobile object positioning and tracking. Besides in-device coordination, a back-off time synchronization method is proposed to resist the time jitters in head-leaves synchronization to provide better localization accuracy.

Furthermore, an ultrasound signature method is also proposed in the present invention in which a unique ID code is assigned for each object to be located and this ID code is modulated into a series of ultrasonic pulses by varying the time interval between the pulses. In this way, the AUITS system of the present invention can be applied flexibly to accurate tracking of a plurality of mobile objects.

### BRIEF DESCRIPTION OF THE DRAWINGS

The foregoing and other features of this invention may be more fully understood from the following description, when read together with the accompanying drawings in which:

FIG. 1 is a block diagram of the complete construction of the Autonomous Ultrasound Indoor Track System (AUITS) 100 of the present invention;

FIG. 2 is a block diagram showing internal structure of an AUITS system 200 according to one embodiment of the present invention;

FIGS. 2A and 2B are PCB layout diagrams showing respectively hardware structures of the POD and the tag device according to the present invention;

FIG. 3 is a schematic diagram showing typical structural examples of the POD of the present invention, in which three cases that the POD includes n=3, 4 or 6 leaf modules are shown;

FIG. 4 is a schematic diagram for showing installation process of the POD of the present invention;

FIG. 5 is a schematic diagram for illustrating a work flow based on role differentiation strategy of the AUITS system according to the present invention;

FIG. 6 is a flow chart diagram for showing the operation 600 of the AUITS system according to the present invention;

FIG. 7 is a schematic diagram for explaining bit alignment error occurred during the POD-tag device synchronization process;

FIG. 8 is a timing chart for explaining the interaction process between the tag device and the POD in the AUITS system according to the present invention; and

FIG. 9 is a block diagram showing internal structure of an AUITS system 900 according to another embodiment of the present invention.

### DETAILED DESCRIPTION OF THE PREFERRED EMBODIMENTS

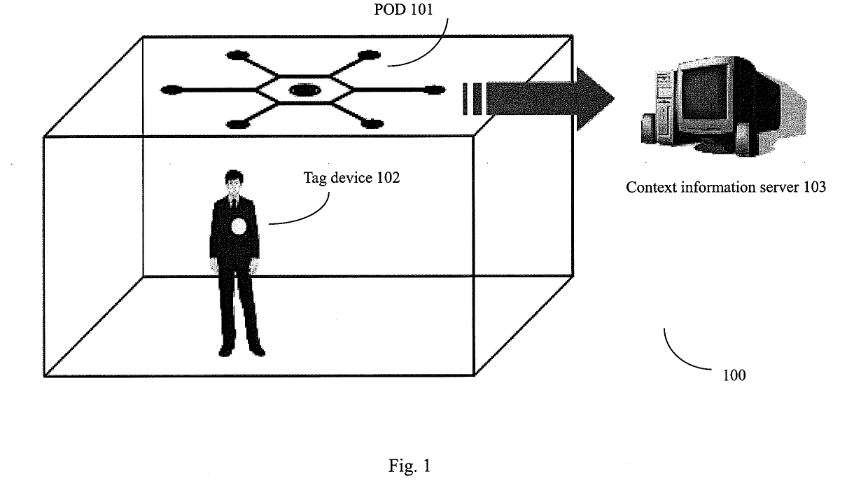

FIG. 1 is a block diagram for showing the complete construction of the Autonomous Ultrasound Indoor Track System (AUITS) 100 according to the present invention. As shown, the system 100 includes a Positioning on One Device (POD) 101, a tag device 102 carried by the object to be located and a context information server 103. In the system 100, the tag device 102 can transmit both of RF signal (synchronization signal) and ultrasound pulse (positioning signal). The POD 101 installed on the ceiling can infer position of the object based on the Time of Arrivals (TOA) of the ultrasound pulses and an adaptive fusion strategy.

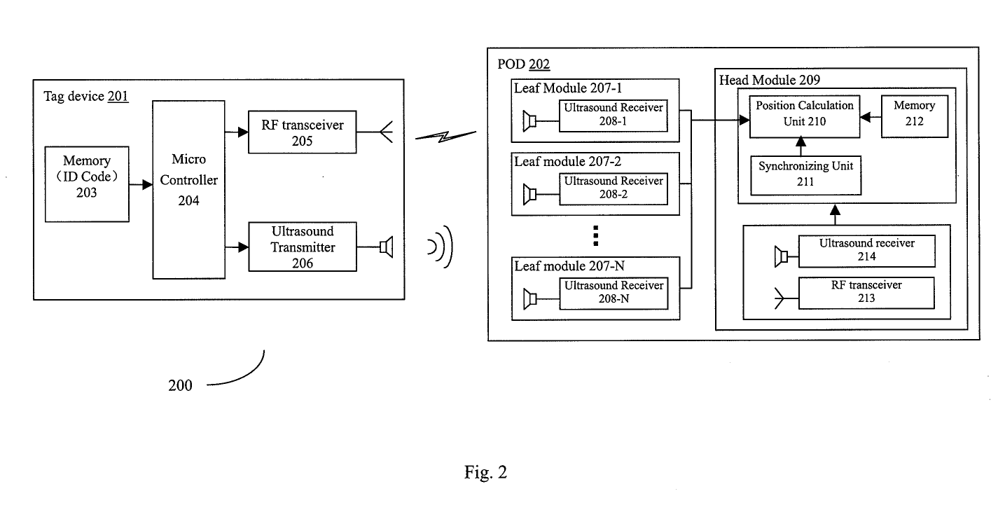

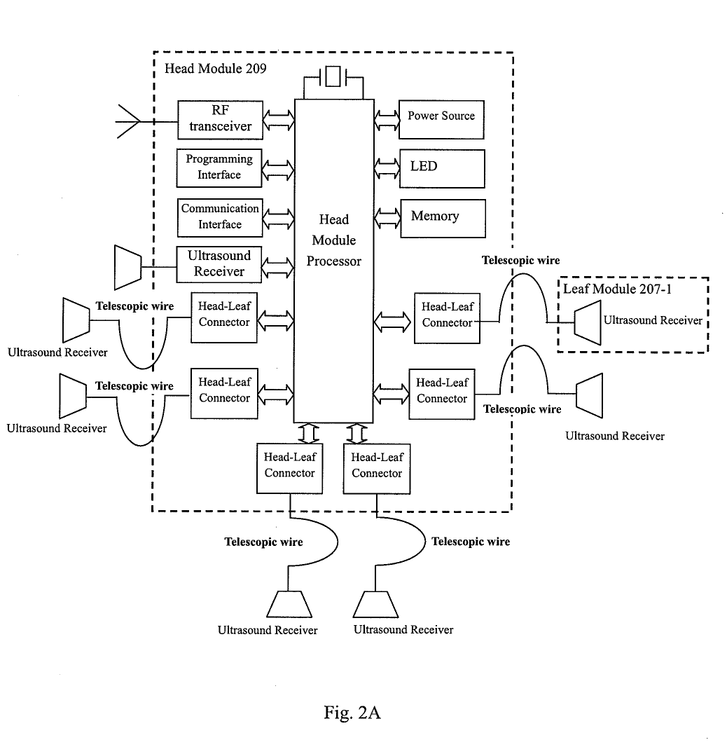

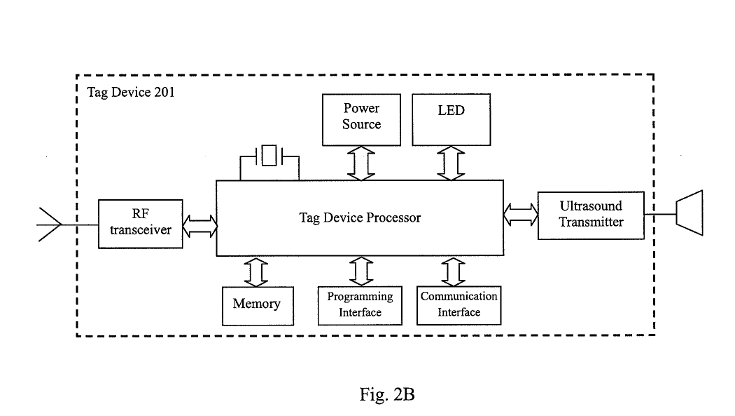

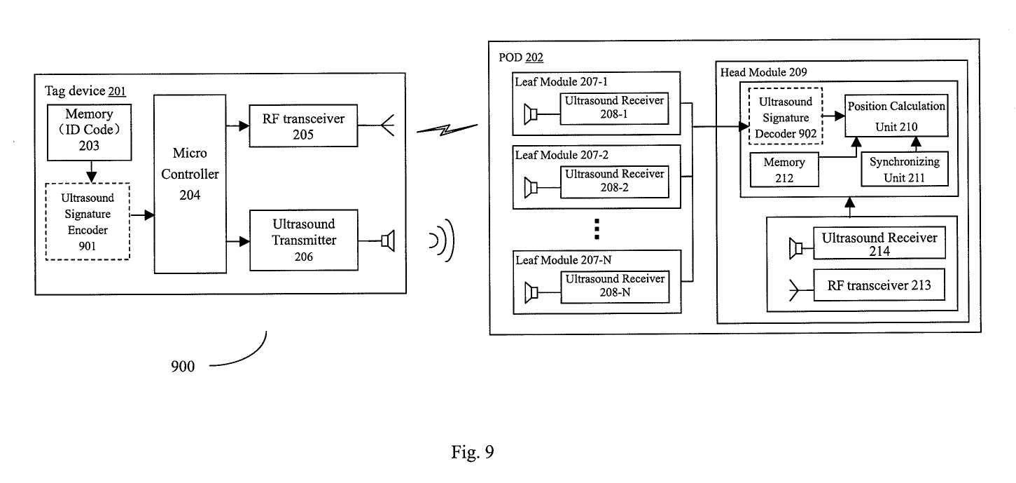

FIG. 2 is a block diagram for showing internal structure of an AUITS system 200 according to one embodiment of the present invention. As shown in FIG. 2, the tag device 201 can include a memory 203, which for example stores an ID code unique to each object. In the following communication, the ID code can be included in the transmitted synchronization or positioning signal for transmission to the receiving side (e.g. POD 202). The receiving side can identify different objects according to the ID codes. For example, as described below regarding another embodiment, the ID code can be encoded in a series of ultrasound pulses (i.e. an ultrasound signature method). Then, the receiving side can obtain ID codes of different objects by decoding the ultrasound pulses. As for the ultrasound signature method, it will be described later in more details with respect to FIG. 9. In addition, the tag device 102 can also include a micro controller 204, a RF transceiver 205 and an ultrasound transmitter 206, which for example can be a narrow band ultrasound transmitter operating on a single frequency of 40 kHz.

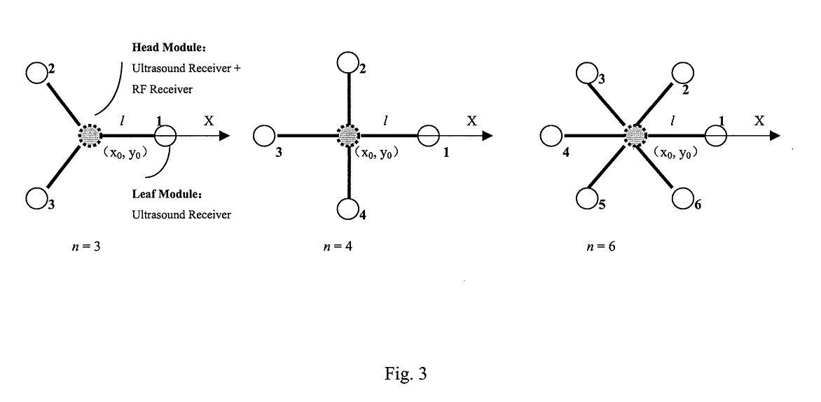

In the exemplified AUITS system 200 as shown in FIG. 2, the POD 202 is shown as comprising a head module 209 and a plurality of leaf modules 207-1, 207-2, . . . 207-N with a known specific structural topology. With reference to FIG. 3, it shows some typical structural examples of the POD of the present invention, in which three cases that the POD includes n=3, 4 or 6 leaf modules are shown. It can be seen from FIG. 3 that in the POD, the head and leaf modules are arranged on the same device, and in the operation status, the head module is in the center of the POD and the leaf modules are connected to and spread out around the head module like the skeleton of an umbrella. Typically, the POD can be designed as having a telescopic structure according to the practical applications. In particular, when not be used (“Compact” status), the initial form of POD is just like a compact “Frisbee” that contains one head module surrounded by several leaf modules. When being used (“Spread” status), the POD can spread several telescopic rods like the skeleton of an umbrella. Return to FIG. 2, the head module 209 of the POD 202 includes a RF transceiver 213 and an ultrasound receiver 214, while each of the leaf modules 207 includes only an ultrasound receiver 208. The head module and each of the leaf modules can for example be connected with a telescopic or foldable wire. In an embodiment, the head module 209 is in charge of calculation of the position of the object. In such a case, the head module 209 can comprise a position calculation unit 210, a synchronizing unit 211 and a memory 212. The memory 212 (e.g. flash memory) can be used to store the structural topology of the POD which is known in advance. For example, in an embodiment, the coordinates of the head and leaf modules can be stored. In another embodiment, the object can be localized under a relative coordinates system, that is, the position of the object with relevant to the POD is calculated. In this way, when installing, it is not necessary to record coordinates for all of the leaf modules, as long as the relative position relationship between the leaf modules and the head module is determined according to formulas. The synchronizing unit 211 performs, based on the received synchronization signal (e.g. RF signal), a back-off method to resist the time jitter in synchronization between the head module and corresponding leaf modules (as described later). The position calculation unit 210 can compute the position of the object according to the Time of Arrivals (TOA) of ultrasound pulses detected by respective ultrasound receivers and the structural topology relationship of the POD.

In an embodiment of the present invention, ultrasound pulse is used for example as positioning signal (distance measurement signal), and thus the position calculation unit 210 calculates the position of the object by using Time of Arrivals (TOA) of ultrasound pulses detected by respective receivers. However, the present invention should not be limited to such specific example. In other embodiments, other signals such as sound wave and mechanical waves can also be used as the positioning signal of the present invention.

As shown in the example of FIG. 2, the position calculation unit 210 of the head module 209 is used to calculate the position of the object. However, the present invention should not be limited to this. According to practical applications, one or more of the leaf modules or an outside server independent of the POD can also be used to calculate the position of the object according to the measurement results of the positioning signals.

FIGS. 2A and 2B are PCB layout diagrams for showing respectively hardware structures of the POD and the tag device according to the present invention. As shown in FIG. 2A, according to the present invention, in order to implement the umbrella-like topology structure of the POD, it is required to make a corresponding circuit design with the topology structure when carrying out PCB circuit design. For example, the PCB circuit can be designed as having scattering interfaces circuit. In addition, to ensure the leaf modules capable of being stretched, it is necessary to employ a telescopic or foldable wire or a similar structure to connect the head module to the leaf modules.

In the hardware diagram shown in FIG. 2A, the head module 209 of the POD is shown as including a head module processor for performing synchronization, record of TOA results, calculation of position of the object and other functions. However, the present invention should not be limited to this. In another embodiment, the leaf module 207 of the POD can include a leaf module processor for recording its TOA measurement result by itself, and one of the leaf modules 207 can be used to calculate the position of the object according to the synchronization time transmitted from the head module, the ultrasound receiver starting time, the structural topology relationship of the POD and so on. In addition, in the case that the leaf module includes the leaf module processor, if necessary, the head module processor and the leaf module processor can be arranged on the same PCB main board or separately.

As shown in FIG. 2A, in addition to the processor for performing the core operations, the Head-Leaf connectors for interfacing the leaf modules, and the RF transceiver and ultrasound receiver as described earlier, the head module 209 can also include a programming interface, a communication interface, a power source, a LED, a memory and so on. Since these components are well-known to those skilled in the art, the detailed description on these components is omitted here.

Furthermore, as described above, in a further embodiment, the TOA and RSS results measured by the leaf and head modules can be sent to an external server, which is used to calculate the position of the object.

In order to simplify the description, a case in which the head module is used for positioning of the object will be described below as an example. Of course, it is easy to understand for those skilled in the art that the present invention can be similarly applied to other cases in which one of the leaf modules or an external server can be used for positioning of the object.

FIG. 2B provides a PCB layout diagram for showing the hardware structure of the tag device. As described above with reference to FIG. 2, the tag device 201 can include a processor, a RF transceiver and an ultrasound transmitter. Similarly to FIG. 2A, description on these components well-known to those skilled in the art, such as the programming interface, the communication interface, the power source, the LED and the memory, will be omitted here. The memory can be used to store ID code specific to each tag device. The ultrasound signature method related to the ID code will be described later.

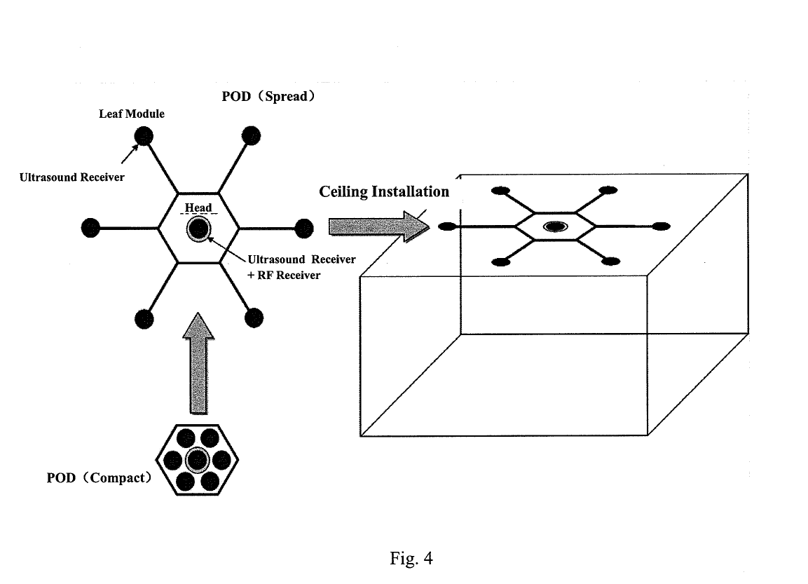

Below, the structure topology of the POD and the process for installing the POD according to the present invention will be described with reference to FIGS. 3 and 4. FIG. 3 is a schematic diagram for showing typical structural examples of the POD of the present invention, wherein three cases that the POD includes n=3, 4 or 6 leaf modules are shown. FIG. 4 is a schematic diagram for showing installation process of the POD of the present invention.

As described above, installation and calibration of ultrasound sensors (receivers) are important factors to make a positioning system feasible into practical applications. Providing initial positions of reference points (no matter ultrasound receivers or beacons) in systems such as the “Bat” or “Cricket” system is a large percentage of the installation overhead. During calibration phase of the conventional systems, the coordinates of the reference points should be precisely determined for better positioning accuracy. However, manual calibration needs considerable user efforts and may lead to error.

To the contrary, one remarkable benefit of the AUITS system according to the present invention is the structural property of the POD, which greatly reduces the calibration efforts and improves the calibration accuracy, thereby enabling the structural-based autonomous self-calibration. The POD of the present invention is designed as one device with structural topology that the angles between the leaf modules and the distances from the leaf modules to the head module are fixed in the infrastructure of the POD. This structural topology eliminates the efforts of measuring the distances, angles among leaf modules and head module. In phrase of calibration, only the coordinates of the head module need manual measurement, while the coordinates of respective leaf modules can be derived automatically from formulas. For example, as shown in the example of FIG. 3, when the direction of the first leaf module is set as the X axis and the distance from each leaf module to the head module is set to be l, in anticlockwise direction, the coordinates of the ith leaf module are given by the following formula (1):

$$\{ \begin{matrix}{x}_{i} = {x}_{0} + l \cdot cos ( \frac{2 π \cdot ( i - 1 )}{n} ) \\ {y}_{i} = {y}_{0} + l \cdot sin ( \frac{2 π \cdot ( i - 1 )}{n} )\end{matrix} \qquad ( 1 )$$

where (x₀,y₀) denotes the coordinate of the head module, n is total number of the leaf modules and l is distance between the head module and respective leaf modules.

FIG. 3 illustrates some typical structural examples of the POD according to the present invention. It can be seen that, comparing with the conventional ultrasonic location systems, POD is more convenient and friendly to users for its easy calibration.

FIG. 4 shows the POD installation process. POD can be installed easily at any positions in the space to be detected, such as the ceiling of the building. After the installation, the coordinates of respective leaf modules can be obtained automatically from the above-described formula (1).

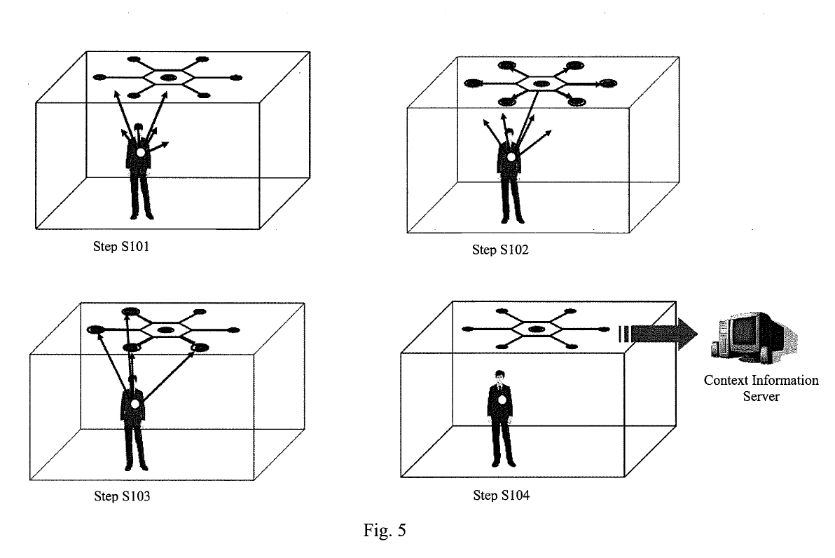

Below, the work flow of the AUITS system of the present invention will be described in more details with reference to FIGS. 5-8.

In a conventional ultrasonic positioning system, all receiver modules have the identical functions and an additional base station is needed to collect signal and infer object's position. A complex signaling and network protocol between ultrasound receivers and the base station is necessary that may lead to a high system cost. To the contrary, there is a collaborative mechanism based on role differentiation strategy is proposed in the present invention for the construction of POD that includes one head node and other leaf nodes which are assigned different jobs and coordinated to jointly carry out mobile object tracking. In the present invention, roles of the head and leaf modules are:
Head module is required to perform the functions including acquisition of the structural topology of POD, reception of the synchronization and positioning signals from the object, performing synchronization with the object, coordination among leaf modules, and position calculation.
Leaf module's task is to acquire positioning signal from the mobile object and report time of detecting the positioning signal to the head module.

Of course, the assignment of tasks among the head and leaf modules is not limited to the above-mentioned example. For those skilled in the art, it is easy to conceive that different tasks can be assigned to the head and leaf modules according to the practical applications. For example, the leaf module can store the positioning signal detection time on its own and accordingly calculate the position of the object. As another example, in the case that there is perfect synchronization between the POD and the object, POD may not include the head module, and all the functions including detection and recording of the positioning signals and calculation of the object position can be performed by the leaf modules.

FIG. 5 shows an example of work flow of the AUITS system according to the present invention, which comprises the following steps.

In the step S101, the tag device carried by the mobile object sends a synchronization signal (e.g. RF signal) firstly, and after back-off duration (as described later), it sends the positioning signal (e.g. ultrasonic pulses).

In the step S102, upon hearing the RF signal, the head module synchronizes itself and all of the connected leaf modules to start ultrasound detectors at the head and leaf modules to wait for the succeeding ultrasound pulses. The Received Signal Strength (RSS) of RF signal can be measured by the head module. In addition, as described above, the tag device can include an ID code specific to the object in the transmitted RF signal for identification of different objects. Therefore, in the synchronization process of step S102, the head module can also obtain the ID code from the received RF signal for identifying the object, so as to achieve more reliable tracking.

Although the head module performs synchronization with the object by using RF signal in this embodiment, the present invention should not be limited to this specific example. For example, POD can use infrared signal, microwave signal or visible light to achieve synchronization with the object. Also, in the case that the leaf module itself can include an appropriate processor, the synchronization process can be performed by the leaf module as long as this leaf module is provided with an apparatus for receiving the synchronization signal (e.g. RF, infrared signal, microwave signal or visible light) from the object.

In the step S103, leaf modules detect the airborne ultrasound signal emitted from the tag device and report the detecting time to the head module. The head module then calculates distances from the leaf modules to the tag device based on the Time of Arrivals (TOA), and an adaptive fusion strategy is utilized for position inferring.

In the step S104, positioning results are sent from POD via wire or wireless network to a context information server.

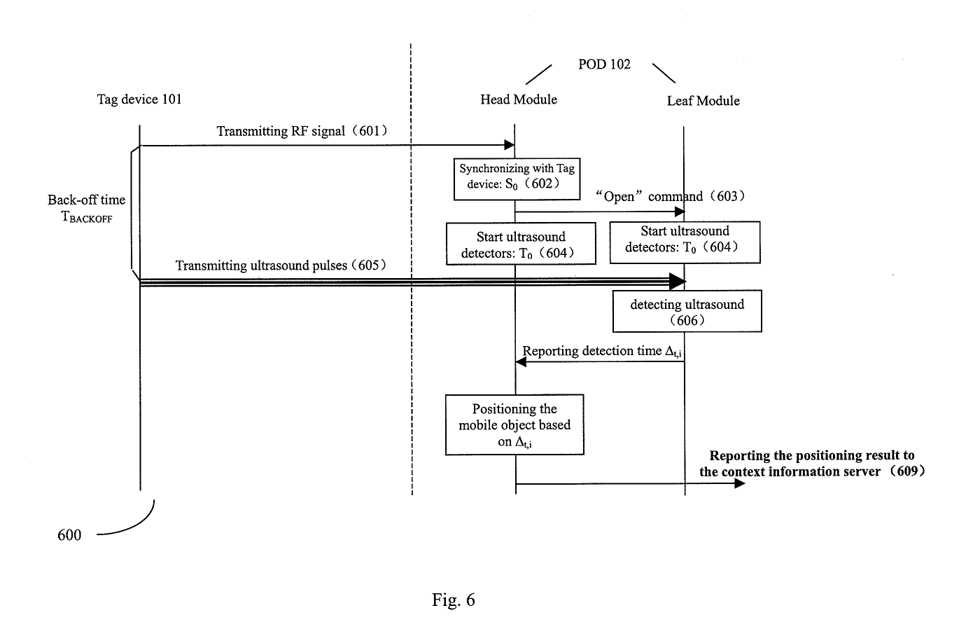

FIG. 6 is a flow chart diagram for showing in more details an example of the operation 600 of the AUITS system according to the present invention. The process 600 starts with the step 601, where the tag device transmits RF signal. Here, the RF signal is received by the head module of the POD 102. The head module of the POD 102 also records Received Signal Strength (RSS) of the RF signal for use later. In the step 602, the head module performs synchronization with the tag device and records the synchronization time S₀. As soon as the head module is synchronized with the tag device, in the step 603, the head module broadcasts “Open” command to the leaf modules to start all of the ultrasound detectors at the head and leaf modules in the step 604. This “Open” command aims to open all the ultrasound detectors of head and leaf modules simultaneously to wait for the ultrasound pulses from the tag device. Here, the head module records the starting time of the ultrasound detectors as T₀. At the tag device 101, after transmitting the RF signal, the tag device waits for a period of back-off time T_{BACKOFF} (as described later) to transmit the ultrasound pulses (step 605). In the step 606, leaf modules detect the ultrasound pulses transmitted from the tag device and report respective detection time Δ_{t,i} to the head module (step 607). Next, in the step 608, the head module calculates distances between respective leaf modules and the tag device according to the ultrasound pulse detection time Δ_{t,i} reported from each of leaf modules and the pre-known structural topology of the POD and then infers the position of the object. In order to improve the accuracy of position measurement, in the step 608, the RSS of the RF signal detected by the head module can also be utilized for facilitating localization of the object. Finally, in the step 609, the head module reports the positioning result to the context information server 103.

TOA method used in AUITS system measures the propagation time of the ultrasound and multiplies it with the ultrasound speed to indicate the distance between the transmitter and the receiver. To precisely measure the TOA, the clocks between the transmitter and the receiver must be precisely synchronized. Because the speed of the ultrasound is around 340 meters per second, if there is one millisecond error in the time synchronization, there will be 34 centimeters error in distance measurement, which is unacceptable to the applications that require high accuracy granularity. Thus, one of the key problems to improve the positioning accuracy is to realize the accuracy of the time synchronization. In the AUITS system of the present invention, there are some potential time uncertainties introduced during the work flow. Based on the structural topology of the POD, we propose a set of time synchronization schemes to eliminate the time uncertainties in the tag device communication and inner device coordination.

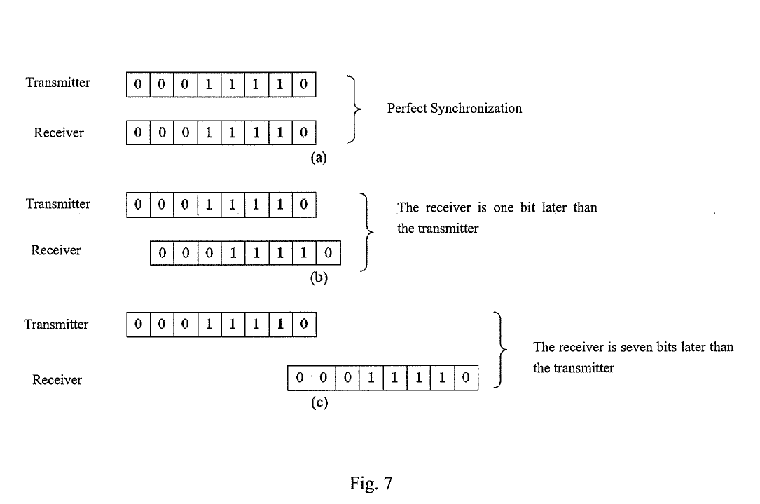

First, the clocks of the tag device and the head module of POD are synchronized by the synchronization signal (e.g. RF signal). In the AUITS system, the head module can know exactly when a certain byte is being sent from the tag device. Since radio wave travels fast enough, it can be understood that sending and receiving one byte via RF occur at the same time. Therefore, both parties for transmitting and receiving are now “synchronized” at byte level. However, due to software overhead and/or interference from preemptions (such as hardware/software interrupts), transmitter and receiver synchronized at the same byte may not be synchronized at the same bit. FIG. 7 is a schematic diagram for explaining bit alignment error occurred during the POD-tag device synchronization process. As shown by (a) in FIG. 7, the ideal case is that the tag device and the head module are synchronized at the same bit. In this case, the clocks of transmitter and receiver are perfectly synchronized. But commonly, caused by the software/hardware delay, there are bit offsets, as shown by (b) and (c) in FIG. 7, resulting in synchronization error.

In the present invention, a compensation method is proposed to eliminate this error by measuring the bit offset at the receiver end. Indeed, in an example, we can invoke the low-level function of TinyOS to obtain the current bit index of that byte. This bit index indicates how much radio receiver lags with transmitter. Since it is a bit offset, the value is between 0 and 7. Value 0 indicates that it lags the most and 7 indicate no lag. Here, we denote the time compensated by bit alignment measurement as T_{comp} and denote the synchronization time of transmitter and receiver as S₀. Then, the time that the transmitter (i.e. the tag device) sends the synchronization byte is S₀−T_{comp}. It should be understood that the method for eliminating the synchronization error between the tag device and the head module is not limited to the method as described above, and it is easy to conceive by those skilled in the art that other methods can also be used to eliminate the synchronization error.

As soon as the head module is synchronized with the tag device, as shown in FIG. 6, the head module broadcasts the “Open” command to the leaf modules to start their ultrasound detectors. This command aims to open all the ultrasound detectors of head and leaf modules simultaneously. According to the symmetry structural topology of POD, the ultrasound detectors at all leaf modules receive this “Open” command almost at the same time in our experiment, with time difference of less than 30 microseconds (i.e., distance error is less than one centimeter). Therefore, the ultrasound detectors of the head and leaf modules are viewed as being opened at the same time, and we denote the opening time with:

Tᵢ=T₀, i=1,2, . . . n (2)

where T₀ denotes the opening time of the ultrasound receiver at the head module, and Tᵢ denotes the opening time of the ultrasound receiver at the ith leaf module. Therefore, according to the present invention, since one centimeter error is tolerable here, we only use T₀ in the head module to express the Tᵢ of other leaf modules, so that we do not need to measure so many Tᵢ at the leaves side. From above analysis, we can find that S₀ is the head-tag synchronization time and T₀ is the opening time of ultrasound receivers of the POD. However, due to the software/hardware interrupts and delays, the time interval of T₀−S₀ is not a fixed value. The time jitters of T₀−S₀ measured in various cases could be larger than 1000 microseconds, so it must be characterized at every measurement for object positioning.

S₀ and T₀ work as a pair of time stamps both measured at the head module, which is much simpler and accessible than measuring them in all the leaf modules. This simplicity is also benefited from the structural design of POD. In every round of object localization, S₀ and T₀ are recorded on-line, thus the time uncertainties from the RF synchronization to the starting of the ultrasound detectors can be controlled.

In a conventional ultrasonic positioning system, the RF and ultrasound signal are emitted from mobile tag at the same time. Correspondingly, the ultrasound detector should be opened simultaneously once receiving RF signal. However, this is not suitable for AUITS according to the present invention. Due to the delay of head-leaves coordination, if the RF signal and the ultrasound pulses are broadcast by the tag device simultaneously, the detector side may miss the first peak of the ultrasound.

Here, a back-off time synchronization scheme is proposed in the present invention to solve such a problem. That is, a constant back-off time is inserted between the transmission of the RF and the ultrasound at tag device side. The purpose is to guarantee that both head and leaf modules can detect the first peak of the ultrasound correctly after opening their ultrasound detectors at the same time. The back-off time is denoted as T_{BACKOFF}. Thus, at receiver side, the ultrasound's emitting time should be inferred as S₀−T_{comp}+T_{BACKOFF}. When a leaf module detects the peak of the ultrasound, it labels its response time Δ_{t,i} and sends it back to the head module. The time Δ_{t,i} is the time from the ultrasound detector's initialization (T₀) to the detection of the ultrasound at the ith leaf module. Thus, the propagation time of ultrasound measured by the ith leaf module, which is denoted by TOAᵢ can be calculated as:

TOAᵢ=(T₀+Δ_{t,i})−(S₀−T_{comp}+T_{BACKOFF}) (3)

where S₀, T_{comp}, and T₀ are measured at the head module; Δ_{t,i} is measured by the ith leaf module and reported to the head module; T_{BACKOFF} is a constant value of back-off time, so that all the values in the above-mentioned formula (3) are known by the head module. TOAᵢ indicates the ultrasound's propagation time before reaching the ultrasound detector of ith leaf module, which can be calculated by the head module.

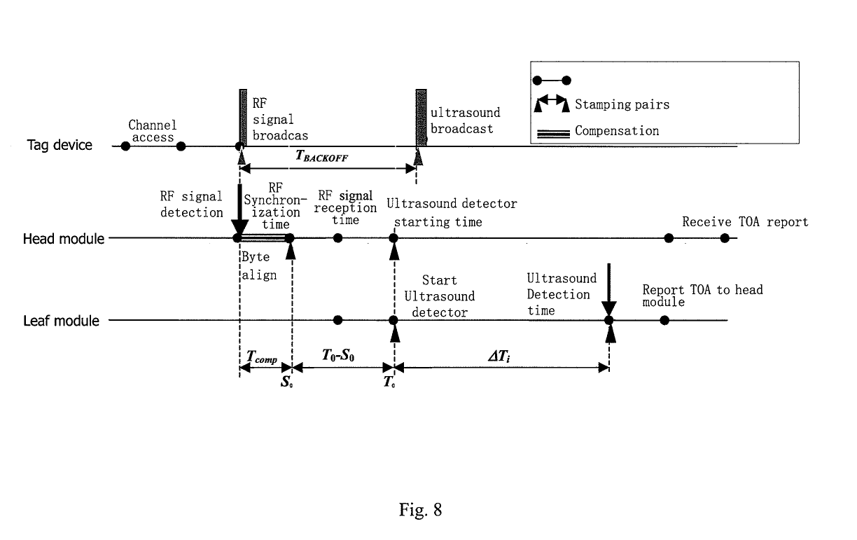

FIG. 8 is a timing chart for explaining the interaction process between the tag device and the POD in the AUITS system according to the present invention, where the back-off time synchronization scheme as mentioned above is explained clearly. Based on the back-off synchronization scheme, POD can calculate the distance between the mobile object and each receiver leaf module correctly and efficiently.

As described above, POD can obtain an ID code specific to the object from the received RF signal during the communication, such as during the synchronization phase between POD and the tag device. However, in another embodiment, the ID code can be transmitted to the POD by encoding a series of ultrasound pulses. Next, an ultrasound signature method for transmitting the ID code with ultrasound will be described with reference to FIG. 9.

FIG. 9 is a block diagram for showing internal structure of an AUITS system 900 according to another embodiment of the present invention. Compared with the embodiment shown in FIG. 2, the tag device in the example of FIG. 2 needs to transmit only ultrasound pulses without ID information for measurement of distance between POD and the tag device. Instead, in the embodiment of FIG. 9, the tag device 201 further comprises an ultrasound signature encoder 901, and correspondingly, the head module 209 of POD 202 further comprises an ultrasound signature decoder 902.

In the example of FIG. 9, the ultrasound signature decoder 902 is shown as a part of the head module 209. However, it can be realized by those skilled in the art that the present invention is not limited to this example. According to applications, the ultrasound signature decoder 902 can also be located in any leaf module 207 or be included in POD 202 as an independent module.

In this embodiment, at the tag device side, the ultrasound signature encoder 901 encodes ultrasound pulses with an ID code (ID signature) specific to the mobile object for generating a segment of encoded ultrasound pulses. When the encoded ultrasound is broadcasted, it can be captured by POD 202, in which the ultrasound signature decoder 902 can decode the ultrasound signal to obtain the ID code for track individual target more reliably.

In an example of the AUITS system, the tag device can utilize a low cost ultrasonic transmitter with a narrow transmission frequency range, for example, 40 kHz to emit ultrasound pulses. In this case, it is not feasible to encode ultrasound by altering the frequency of the transmitted ultrasound wave just like the “Soniter” system. Instead, the tag device is configured to transmit a series of single frequency ultrasound pulses in quick succession. More exactly, the ID code of the target can be embedded into a series of pulses by varying the transmission time of each of the pulses according to a set of predefined intervals. For example, assume that there is a n-bit ID code {c₁, c₂, c₃, cₙ}, the transmission interval of the series of ultrasound pulses can be defined as:

$$Intvl = \{ \begin{matrix}MinIntvl & if {c}_{i} = 0 \\ 2 * MinIntvl & if {c}_{i} = 1\end{matrix} \qquad ( 4 )$$

where MinIntvl is the minimum interval between pulses.

It can be realized by those skilled in the art that the method for encoding the ID code with ultrasound is not limited to the example as described above. In the case that different ultrasound transmitters are used, other encoding methods for encoding the ultrasound pulse series well-known in the art can also be used, such as time encoding, amplitude modulation, frequency modulation, phase modulation and the like.

The forgoing description has been made with reference to the accompanying drawings to illustrate the special structural topology of the Positioning on One Device (POD) and the structure and work flow of the AUITS system for positioning and tracking mobile objects using the POD according to the present invention. From the above description, the effects of the present invention are as follows.

The AUITS of the present invention employs an autonomous positioning device, i.e. POD, to process collection of the positioning signal (e.g. ultrasound signal) and to make position inferring, instead of networked ultrasound sensors as the prior arts deployed, and thus it is easily to be installed and maintained. In addition, the special structural topology of the POD is designed that coordinates of head and leaf modules can be automatically obtained by formulas. Therefore, manual calibration is no longer needed.

In addition, the back-off time synchronization method that is proposed in the present invention can resist the time jitters in head-leaves synchronization to provide better localization accuracy.

Furthermore, an ultrasound signature method is also proposed in the present invention in which a unique ID code is assigned for each object to be located and this ID code is modulated into a series of ultrasonic pulses by varying the time interval between the pulses. In this way, the AUITS system of the present invention can be applied flexibly to accurate tracking of a plurality of mobile objects.

Although the specific embodiments of the present invention have been described above with reference to the accompanying drawings, the present invention is not limited to the particular configuration and processing shown in the accompanying drawings. Also, for the purpose of simplification, the description to these existing methods and technologies is omitted here.

In the above embodiments, several specific steps are shown and described as examples. However, the method process of the present invention is not limited to these specific steps. Those skilled in the art will appreciate that these steps can be changed, modified and complemented or the order of some steps can be changed without departing from the spirit and substantive features of the invention.

Although the invention has been described above with reference to particular embodiments, the invention is not limited to the above particular embodiments and the specific configurations shown in the drawings. For example, some components shown may be combined with each other as one component, or one component may be divided into several subcomponents, or any other known component may be added. The operation processes are also not limited to those shown in the examples. Those skilled in the art will appreciate that the invention may be implemented in other particular forms without departing from the spirit and substantive features of the invention. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A positioning device for locating objects, comprising:
a plurality of leaf modules, each of the leaf modules including a positioning signal receiver for receiving positioning signals transmitted from the object, wherein there is a known structural topology relationship between the plurality of leaf modules; and
a computing module for computing the position of the object according to positioning signal detection times from respective positioning signal receivers and the structural topology relationship.

2. The positioning device according to claim 1, further comprising a head module, which comprises:
a synchronization signal receiver for receiving synchronization signal; and
a synchronization unit for performing synchronization with the object.

3. The positioning device according to claim 2, wherein the head module further comprises a positioning signal receiver for receiving the positioning signals.

4. The positioning device according to claim 2, wherein the plurality of leaf modules is arranged around the head module, and when the positioning device is used, the plurality of leaf modules is in a spread state, when the positioning device is not used, the plurality of leaf modules is in a compact state.

5. The positioning device according to claim 2, wherein the synchronization signal includes an ID code specific to the object, and the positioning device obtains the ID code by receiving the synchronization signal.

6. The positioning device according to claim 1, wherein the positioning signal includes an ID code specific to the object, and the positioning device obtains the ID code by receiving the positioning signal.

7. A method for locating objects using a positioning device, the positioning device comprises a plurality of leaf modules, each of the leaf modules includes a positioning signal receiver for receiving positioning signals transmitted from the object, wherein there is a known structural topology relationship between the plurality of leaf modules, the method comprising:
starting the positioning signal receivers and recording the start time T_{0,i} of the positioning signal receivers, wherein i is an index for the ith positioning signal receiver;
receiving the positioning signals from the object by each of the positioning signal receivers and recording its positioning signal detection time Δ_{t,i}; and
calculating the position of the object based on the recorded positioning signal detection times and the structural topology relationship of the positioning device.

8. The method according to claim 7, further comprising:
receiving a synchronization signal from the object; and
synchronizing the positioning device with the object according to the synchronization signal.

9. The method according to claim 8, wherein at the object, a predetermined back-off time is inserted between the transmission of the synchronization signal and the positioning signals.

10. The method according to claim 8, wherein the synchronization signal includes an ID code specific to the object, the method further comprises:
obtaining the ID code from the synchronization signal.

11. The method according to claim 7, wherein the positioning signal includes an ID code specific to the object, the method further comprises:
obtaining the ID code from the positioning signal.

12. An autonomous ultrasound track system for locating objects, comprising:
a tag device installed on a object, which includes a positioning signal transmitter for transmitting positioning signals; and
a positioning device for locating the position of the object, wherein the positioning device comprises:
a plurality of leaf modules, each of the leaf modules including a positioning signal receiver for receiving the positioning signals transmitted from the object, wherein there is a known structural topology relationship between the plurality of leaf modules; and
a position computing module for computing the position of the object according to positioning signal detection times from respective positioning signal receivers of the positioning device and the structural topology relationship.

13. The system according to claim 12, wherein the tag device further includes a synchronization signal transmitter for transmitting synchronization signal.

14. The system according to claim 12, wherein the position computing module is integrated into one of the leaf modules of the positioning device.

15. The system according to claim 12, further comprising a server, and the position computing module is integrated into the server.

16. An ultrasound signature method, comprising:
obtaining an ID code specific to an object;
encoding the ID code into a sequence of ultrasound pulses to be transmitted; and
transmitting the encoded sequence of ultrasound pulses.

17. The ultrasound signature method according to claim 16, wherein the step of encoding comprises at least one of:
varying the transmission time of each of the ultrasound pulses in the ultrasound pulses sequence according to the ID code, and
performing amplitude modulation, frequency modulation or phase modulation operation on the sequence of ultrasound pulses according to the ID code.

18. A tag device, comprising:
a synchronization signal transmitter for transmitting synchronization signals; and
a positioning signal transmitter for transmitting positioning signals,
wherein a predetermined period of time is inserted between the transmission of the synchronization signals and the positioning signals.

19. The tag device according to claim 18, wherein the synchronization signal includes an ID code specific to the object.

20. The tag device according to claim 18, wherein the positioning signal includes an ID code specific to the object.
